(19) United States
(12) Patent Application Publication
(10) Pub. No.: US 2015/0151774 A1
(43) Pub. Date: Jun. 4, 2015

(54) FOLDING JOINT SUITABLE FOR BABY CARRIAGES

(71) Applicant: Unitron Enterprises Zhuhai Co., Ltd., Zhuhai, GU (CN)

(72) Inventor: Xiuping Liu, Zhuahai (CN)

(21) Appl. No.: 14/414,144

(22) PCT Filed: Jan. 27, 2014
(86) PCT No.: PCT/CN2014/071565

§ 371 Date: Jan. 12, 2015

(30) Foreign Application Priority Data
Jan. 28, 2013 (CN) 201210032148.9
Jan. 28, 2013 (CN) 201320046038.3

(51) Int. Cl. B62B 7/10; B62B 7/06

(52) U.S. Cl. CPC B62B 7/10; B62B 7/06

(57) ABSTRACT

A folding joint suitable for a baby carriage, including a lower rotary plate, an upper rotary plate, a rotary plate positioning cover, at least one traction cable and a stopper for preventing said upper rotary plate or said lower rotary plate from turning. Said upper rotary plate is connected with said lower rotary plate by said at least one traction cable. Said lower rotary plate can turn about one pivot point provided in said rotary plate positioning cover, and said upper rotary plate can turn about another pivot point provided in said rotary plate positioning cover. When said stopper is released, said upper rotary plate or said lower rotary plate is turned, thereby driving said lower rotary plate or said upper rotary plate to turn by said traction cable through which said upper rotary plate is connected with said lower rotary plate.

### CROSS-REFERENCE TO RELATED APPLICATION

This is a U.S. national application filed under 35 U.S.C. §371 of International Application No. PCT/CN2014/071565, filed Jan. 27, 2013, which claims priority to Chinese National Application No. 201310032148.9, filed Jan. 28, 2013, and Chinese National Application No. 201320046038.3, filed Jan. 28, 2013, the entire disclosures of which applications are expressly incorporated herein by reference.

### FIELD OF THE DISCLOSURE

Embodiments of the present disclosure relate generally to a folding joint suitable for use in a baby carriage. More specifically, the present disclosure relates to a folding joint for a baby carriage that mitigates the risk of a user's fingers being jammed or struck.

### BACKGROUND OF THE DISCLOSURE

Folding baby carriages commonly employ a linkage mechanism having a folding joint that is used to pivotably connect a front supporting tube to a handle tube. A disadvantage associated with such a configuration is that when the front supporting tube and the handle tube are folded together a user's fingers may accidentally be jammed or caught therebetween. Some folding baby carriages may additionally or alternatively employ a gear transmission mechanism including a folding joint having upper and lower folding portions. The gears of such a gear transmission mechanism are typically exposed, which also creates a jamming and/or pinching hazard.

Recently, governmental and consumer organizations around the world have begun placing more emphasis on the safety of folding baby carriages, particularly with regard to the folding joints of such carriages and the jamming/pinching hazards associated therewith. It would therefore be advantageous to provide a folding baby carriage having joints that mitigate the risk of a user's finger's becoming jammed, caught, or pinched therein.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

The disclosure provides a folding joint for a baby carriage, including an upper rotary plate provided with a positioning hole, a lower rotary plate provided with a positioning hole, a rotary plate outer positioning cover provided with two positioning holes which respectively correspond to the positioning hole in the upper rotary plate and the positioning hole in the lower rotary plate, and a rotary plate inner positioning cover provided with two positioning holes which respectively correspond to the positioning hole in the upper rotary plate and the positioning hole in the lower rotary plate. Said upper rotary plate is connected with said rotary plate outer positioning cover and said rotary plate inner positioning cover through the respective positioning holes, thereby forming a first pivot point. Said lower rotary plate is connected with said rotary plate outer positioning cover and said rotary plate inner positioning cover through the respective positioning holes, thereby forming a second pivot point. Said upper rotary plate can turn about the first pivot point and said lower rotary plate can turn about the second pivot point.

In another embodiment, a folding joint suitable for a baby carriage in accordance with the present disclosure may include a lower rotary plate, an upper rotary plate, a rotary plate positioning cover, at least one traction cable, and a stopper for preventing said upper rotary plate or said lower rotary plate from turning. Said upper rotary plate is connected with said lower rotary plate by said at least one traction cable. Said lower rotary plate can turn about one pivot point provided in said rotary plate positioning cover, and said upper rotary plate can turn about another pivot point provided in said rotary plate positioning cover. When said stopper is released, said upper rotary plate or said lower rotary plate is turned, thereby driving said lower rotary plate or said upper rotary plate to turn by said traction cable through which said upper rotary plate is connected with said lower rotary plate.

Further, the rotary plate positioning cover includes a rotary plate outer positioning cover and a rotary plate inner positioning cover which are respectively provided with positioning holes, and said upper rotary plate and said lower rotary plate are also respectively provided with corresponding positioning holes. Said rotary plate outer and inner positioning cover are connected with said upper and lower rotary plate through said positioning holes, thereby forming two pivot points.

Further, both of said upper rotary plate and said lower rotary plate are provided with a stopping part at their respective lower ends, and said stopper is movably installed in stopping areas near the lower ends of the upper and lower rotary plate. When said stopper is engaged with the stopping part of said upper rotary plate or said lower rotary plate, said upper rotary plate or said lower rotary plate cannot turn about the pivot points. When said stopper is released from the stopping part of said upper rotary plate or said lower rotary plate, said upper rotary plate or said lower rotary plate is turned, thereby driving said lower rotary plate or said upper rotary plate to turn by the traction cable.

Further, both of said upper rotary plate and said lower rotary plate are provided with a stopping part at their respective lower ends, and said upper rotary plate is connected with said lower rotary plate by at least one traction cable, which can be installed in the small retaining nests arranged respectively in peripheral end surfaces of said upper rotary plate and said lower rotary plate. One end of said traction cable is installed in a fixed point and the small retaining nest in the peripheral end surface of the upper end of said upper rotary plate, and another end of said traction cable is installed in a fixed point and the small retaining nest in the peripheral end surface of the lower end of said lower rotary plate. When said stopper is released from the stopping part of said upper rotary plate or said lower rotary plate, said upper rotary plate is turned about the pivot point in the rotary plate positioning cover in the clockwise direction, thereby driving said lower rotary plate to turn about the another pivot point in said rotary plate positioning cover in the counterclockwise direction by said traction cable.

Further, both of said upper rotary plate and said lower rotary plate are provided with a stopping part at their respective lower ends, and said upper rotary plate is connected with said lower rotary plate by two traction cables, which can be respectively installed in the small retaining nests arranged respectively in peripheral end surfaces of said upper rotary plate and said lower rotary plate. One end of the first traction cable is installed in a fixed point and the small retaining nest in the peripheral end surface of the upper end of said upper rotary plate, and another end of said first traction cable is installed in a fixed point and the small retaining nest in the peripheral end surface of the lower end of said lower rotary plate. One end of the second traction cable is installed in a fixed point and the small retaining nest in the peripheral end surface of the lower end of said upper rotary plate, and another end of said second traction cable is installed in a fixed point and the small retaining nest in the peripheral end surface of the upper end of said lower rotary plate. When said stopper is released from the stopping part of said upper rotary plate or said lower rotary plate, said upper rotary plate is turned about one pivot point in the rotary plate positioning cover in the clockwise direction, thereby driving said lower rotary plate to turn about the another pivot point in said rotary plate positioning cover in the counterclockwise direction by said first traction cable, and then said upper rotary plate is turned about one pivot point in said rotary plate positioning cover in the counterclockwise direction, thereby driving said lower rotary plate to turn about the another pivot point in said rotary plate positioning cover in the clockwise direction by said second traction cable.

Further, both of said upper rotary plate and said lower rotary plate have a P-shaped rotation arm. The rotation arm of the lower rotary plate is fixedly connected with the front supporting tube of the baby carriage, the rotation arm of the upper rotary plate is fixedly connected with the handle tube of the baby carriage, and said rotary plate positioning cover is fixedly connected with the rear supporting tube of the baby carriage.

Further, the rotation arm of said lower rotary plate is fixedly connected with the handle tube of the baby carriage, the rotation arm of the upper rotary plate is fixedly connected with the rear supporting tube of the baby carriage, and said rotary plate positioning cover is fixedly connected with the front supporting tube of said baby carriage.

Further, the rotation arm of said lower rotary plate is fixedly connected with the rear supporting tube of the baby carriage, the rotation arm of the upper rotary plate is fixedly connected with the front supporting tube of the baby carriage, and said rotary plate positioning cover is fixedly connected with the handle tube of said baby carriage.

Based on the above described technical schemes of the present invention, the traction cable(s) for connecting the upper rotary plate with the lower rotary plate is(are) closed in small retaining nests in the rotary plate positioning cover and the rotary plate by making the upper and lower rotary plate turn about two pivot points in the rotary positioning cover. Even if the rotary plate positioning cover is exposed when the upper and lower rotary plate turn dynamically, a gap where fingers is jammed, is not generated between them. By using a baby carriage made from such a folding joint, it is unnecessary for any exposed connecting rods to be arranged between handle tube and front/rear supporting tube. Therefore, the problem of fingers being jammed or struck during folding a baby carriage will be well solved by the folding joint of the baby carriage, so that the baby carriage can be used safely and securely by infants' parents.

### BRIEF DESCRIPTION OF THE DRAWINGS

By way of example, various embodiments of the disclosed device will now be described, with reference to the accompanying drawings, in which:

FIG. 1 is a structural view showing schematically a baby carriage frame and an embodiment of a folding joint suitable for the baby carriage according to the present disclosure;

FIG. 2 is an assembly view showing schematically an embodiment of a folding joint suitable for the baby carriage according to the present disclosure;

FIG. 3 is an exploded view showing schematically an embodiment of a folding joint suitable for the baby carriage according to the present disclosure;

FIG. 4 is an assembly view showing schematically an embodiment of a folding joint suitable for the baby carriage according to the present disclosure;

FIGS. 5A and 5B are schematic views showing respectively functional parts of the upper and lower rotary plate of an embodiment of a folding joint suitable for the baby carriage according to the present disclosure;

FIGS. 6A and 6B are schematic views showing respectively traction cables located between the upper and lower rotary plate of an embodiment of a folding joint suitable for the baby carriage according to the present disclosure;

FIG. 7 is schematic views showing schematically the relation between the stopper and the stopping parts of an embodiment of a folding joint suitable for the baby carriage according to the present disclosure;

FIGS. 8A and 8B are schematic views showing respectively the stopper of an embodiment of a folding joint suitable for the baby carriage according to the present disclosure, the stopper being released in FIG. 8A, and the lower rotary plate being turned in the counterclockwise direction by the upper rotary plate which is turned in the clockwise direction in FIG. 8B;

FIG. 9 is a schematic view showing a state where fingers is not jammed when the folding joint suitable for the baby carriage according to the present disclosure has been folded; and

FIG. 10 is an assembly view showing a folding joint for a separate seat of the baby carriage, the present disclosure being applied in the folding joint.

### DETAILED DESCRIPTION

Technical schemes of the disclosure will be further described in more detail with reference to the specific embodiments and the drawings.

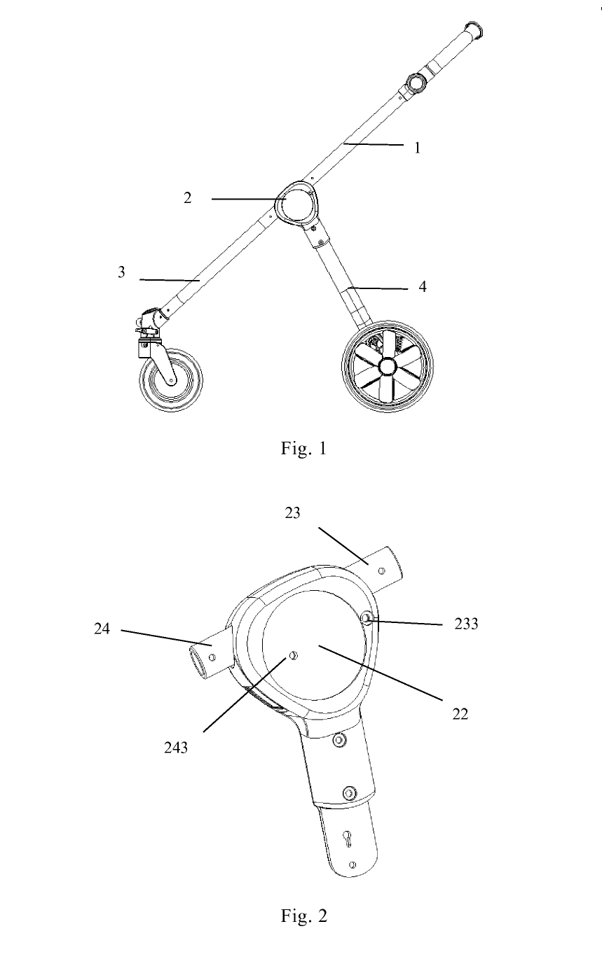

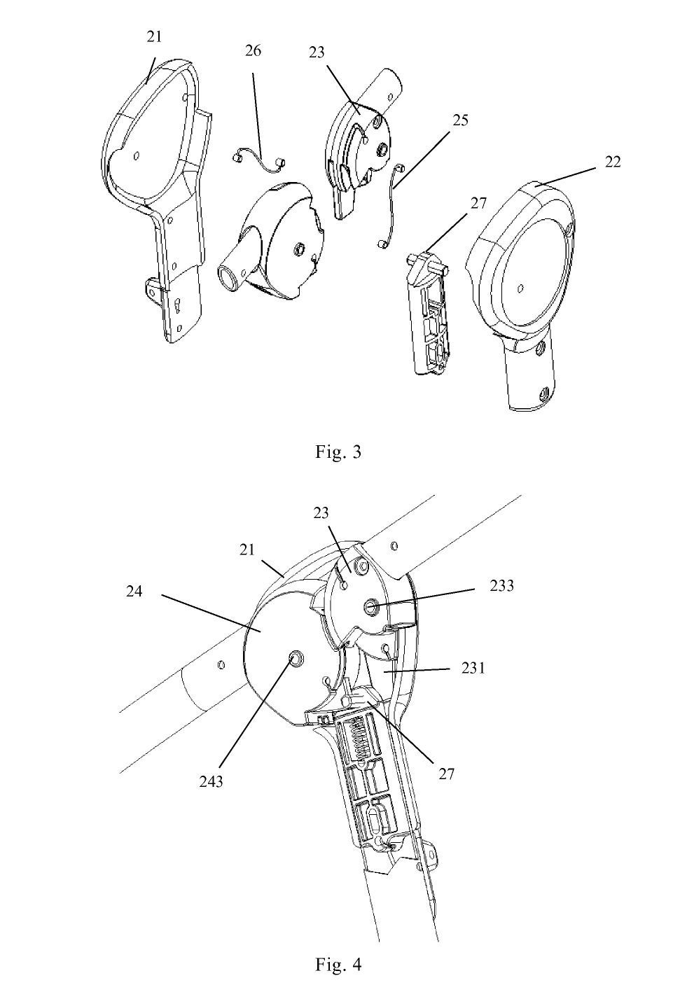

As shown in FIG. 2 and FIG. 3, a schematic assembly view and a schematic exploded view of an embodiment of a folding joint 2 for a baby carriage according to the present disclosure are respectively shown. In the embodiment, the folding joint 2 includes a lower rotary plate 24, an upper rotary plate 23, a rotary plate positioning cover which may include a rotary plate outer positioning cover 22 and a rotary plate inner positioning cover 21, at least one traction cable 25, and a stopper 27 for preventing the upper rotary plate 23 and the lower rotary plate 24 from turning. With respect to a baby carriage frame shown in the FIG. 1, the lower rotary plate 24 may be fixedly connected with a front supporting tube 3, the upper rotary plate 23 may be fixedly connected with a handle tube 1 of the baby carriage frame, and the rotary plate positioning cover which may include the rotary plate outer positioning cover 22 and the rotary plate inner positioning cover 21 may be fixedly connected with a rear supporting tube 4 of the baby carriage.

As is apparent from FIG. 3, the rotary plate positioning cover of folding joint 2 may include the rotary plate outer positioning cover 22 and the rotary plate inner positioning cover 21 respectively provided with corresponding positioning holes, and the upper rotary plate 23 and the lower rotary plate 24 are also respectively provided with corresponding positioning holes. The rotary plate outer and inner positioning covers 22 and 21 and the upper and lower rotary plate 23 and 24 are pivotally connected together by means of these positioning holes, forming a pivot point 233 and a pivot point 243 (see FIG. 2).

With reference to the schematic assembly view shown in FIG. 4, the upper rotary plate 23 is connected with the lower rotary plate 24 by at least one traction cable 25, the lower rotary plate 24 can turn about the pivot point 243 of pivot points provided in the rotary plate inner and outer positioning cover 21 and 22, and the upper rotary plate 23 can turn about the another pivot 233 of the above described pivot points. When the stopper 27 is released, the upper rotary plate 23 is turned, thereby driving the lower rotary plate 24 to turn by the traction cable 25 which is connected to the upper rotary plate 23, or the lower rotary plate 24 is turned, thereby driving the upper rotary plate 23 to turn by the traction cable 25.

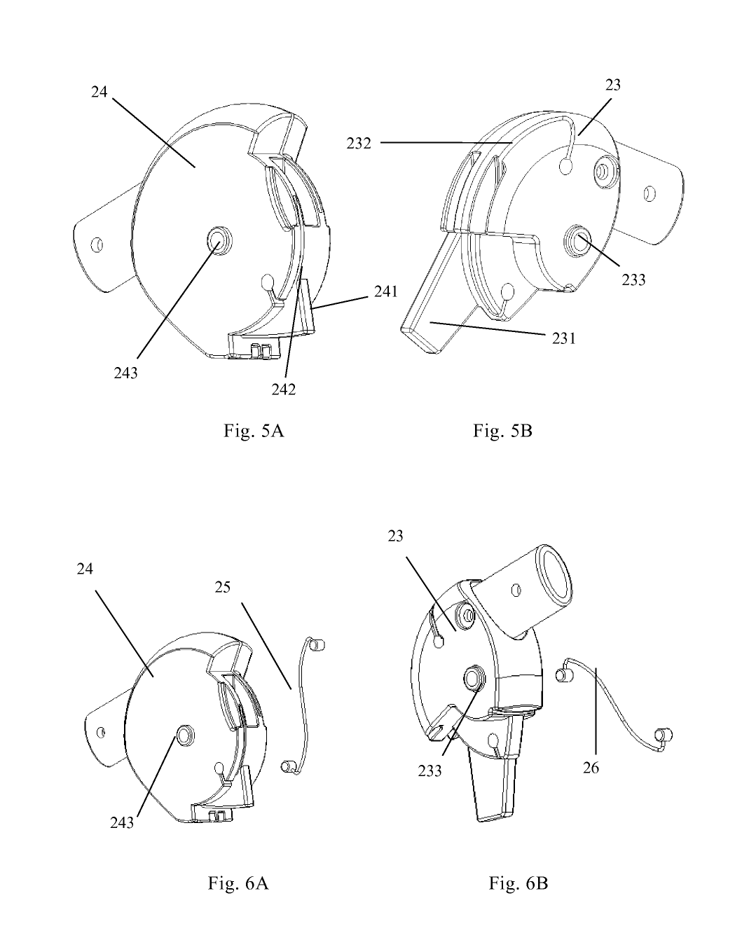

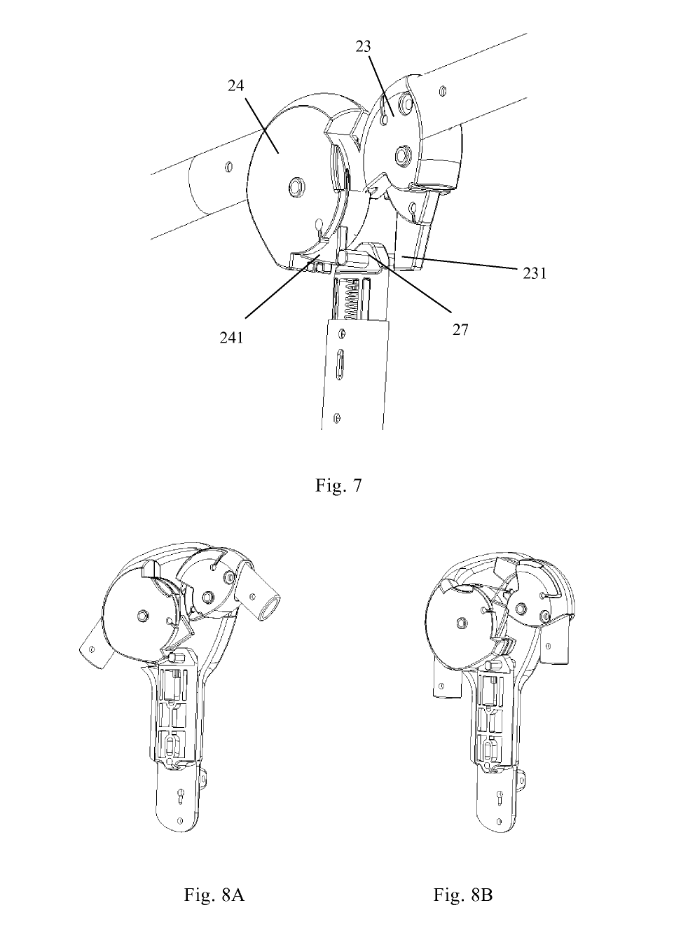

In the embodiment shown in FIG. 5, the upper rotary plate 23 and the lower rotary plate 24 are respectively provided with a stopping part 231 and a stopping part 241 at their respective lower ends. As shown in FIG. 7, the stopper 27 can be movably arranged at stopping areas near the lower ends of the upper rotary plate 23 and the lower rotary plate 24. The upper rotary plate 23 cannot turn about the pivot point 233 when the stopper 27 is engaged with the stopper 231 of the upper rotary plate 23, or the lower rotary plate 24 cannot turn about the pivot point 243 when the stopper 27 is engaged with the stopper 241 of the lower rotary plate 24.

With reference to FIGS. 8A and FIG. 8B, when the stopper 27 is released from the stopping part 231 of the upper rotary plate 23, the upper rotary plate 23 is allowed to turn (through force of gravity), thereby driving the lower rotary plate 24 to turn by the traction cable 25. When the stopper 27 is released from the stopping part 241 of the lower rotary plate 24, the lower rotary plate 24 is turned, thereby driving the upper rotary plate 23 to turn by the traction cable 25.

With reference to FIGS. 5A, 5B and 8, the upper rotary plate 23 and the lower rotary plate 24 of the folding joint 2 are respectively provided with small retaining nests 232 and 242 at their respective peripheral end surfaces, for installing the traction cable. The upper rotary plate 23 is connected with the lower rotary plate 24 by one traction cable 25, one end of which is installed in a fixed point and the small retaining nest 232 in peripheral end surface of the upper end of the upper rotary plate 23, another end of which is installed in a fixed point and the small retaining nest 242 in peripheral end surface of the lower end of the lower rotary plate 24. When the stopper 27 is released from the stopping part 231 of the upper rotary plate 23 or the stopping part 241 of the lower rotary plate 24, the upper rotary plate 23 is turned about the pivot point 233 in the rotary plate positioning cover in the clockwise direction, thereby driving the lower rotary plate 24 to turn about the another pivot point 243 in the rotary plate positioning cover in the counterclockwise direction by the traction cable 25.

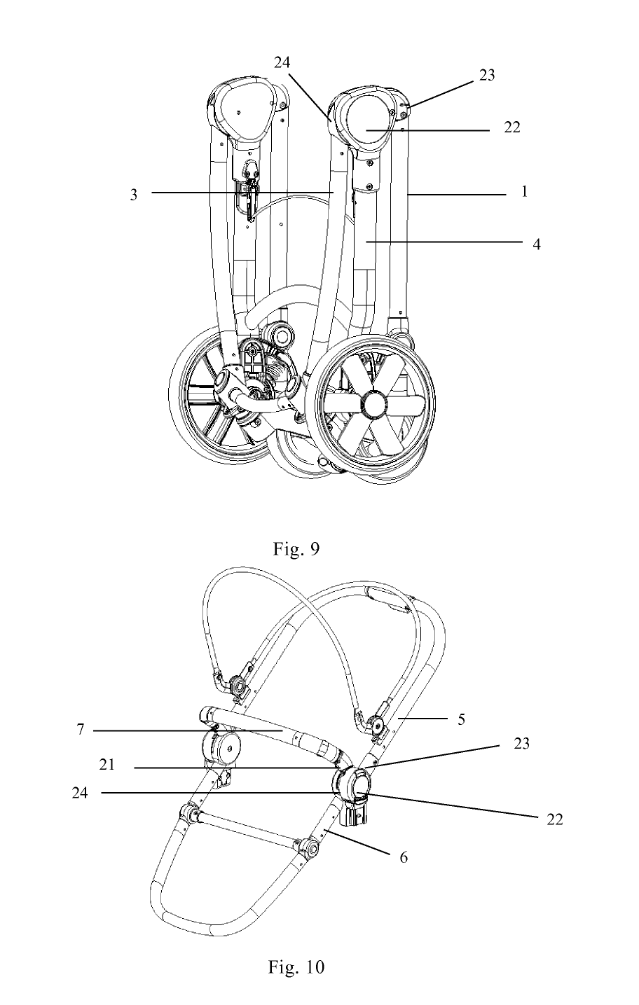

Both the upper rotary plate 23 and the lower rotary plate 24 have a P-shaped rotating arm. The rotating arm of the lower rotary plate 24 is fixedly connected with the front supporting tube 3 of the baby carriage, the rotating arm of the upper rotary plate 23 is fixedly connected with the handle tube 1 of the baby carriage, and the rotary plate positioning cover 21 and 22 are fixedly connected with the rear supporting tube 4, thereby there being no gap where a user's fingers can be jammed or caught after the baby carriage frame is folded, shown in detail in FIG. 9.

In one embodiment, the connection between the upper rotary plate 23 and the lower rotary plate 24 of the folding joint may include an additional traction cable 26 (as shown in FIG. 3). One end of the traction cable 25 is installed in a fixed point in the small retaining nest 232 in the peripheral end surface of the upper end of the upper rotary plate 23, and another end of the traction cable 25 is installed in a fixed point in the small retaining nest 242 in the peripheral end surface of the lower end of the lower rotary plate 24. One end of the traction cable 26 is installed in a fixed point in a small retaining nest (not within view) in the peripheral end surface of the lower end of the upper rotary plate 23, and another end of the traction cable 26 is installed in a fixed point in a small retaining nest (not within view) in the peripheral end surface of the lower end of the lower rotary plate 24.

When the stopper 27 is released from the stopping part 231 of the upper rotary plate 23 or the stopping part 241 of the lower rotary plate 24, the upper rotary plate 23 is turned about the pivot point 233 in the rotary plate positioning cover in the clockwise direction, driving the lower rotary plate 24 to turn about the another pivot point 243 in the counterclockwise direction by the traction cable 25, and then the upper rotary plate 23 is turned about the pivot point 233 in the rotary plate positioning cover in the counterclockwise direction, driving the lower rotary plate 24 to turn about the another pivot point 243 in the clockwise direction by the traction cable 26.

In another embodiment, the rotating arm of the lower rotary plate 24 may be fixedly connected with the handle tube 1 of the baby carriage, the rotating arm of the upper rotary plate 23 may be fixedly connected with the rear supporting tube 4 of the baby carriage, and the rotary plate inner and outer positioning cover 21 and 22 may be fixedly connected with the front supporting tube 3 of the baby carriage.

In another embodiment, the rotating arm of the lower rotary plate 24 also may be fixedly connected with the rear supporting tube 4 of the baby carriage, the rotating arm of the upper rotary plate 23 may be fixedly connected with the front supporting tube 3 of the baby carriage, and the rotary plate inner and outer positioning cover 21 and 22 may be fixedly connected with the handle tube 1 of the baby carriage.

In another embodiment, the folding joint 2 also may be used as a folding joint for a separate seat of the baby carriage. As seen in FIG. 10, the rotating arm of the lower plate 24 is fixedly connected with a seat tube 6 of the seat, and the rotating arm of the upper plate 23 is fixedly connected with a backrest tube 5 of the seat, with the rotary plate inner and outer positioning covers 21 and 22 being used as connectors to connect the seat with the baby carriage, or being used as armrest connecting bases of the separate seat, which can be connected with armrest tube 7 of the seat.

As is apparent from the above several embodiments of the present disclosure, no matter how the handle tube, the front supporting tube, or the rear supporting tube of the baby carriage are connected with the upper rotary plate, the lower rotary plate or the rotary plate positioning cover, the present disclosure is applicable in a folding joint of any baby carriage frame, and no matter how the rear rest tube, seat tube, or the handle tube of the seat are connected with the folding joint, the present disclosure is applicable in a folding joint of a separate seat in a baby carriage. All of these embodiments fall within the scope of the present disclosure.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The present disclosure is not to be limited in scope by the specific embodiments described herein. Indeed, various other embodiments of and modifications to the present disclosure, in addition to those described herein, will be apparent to those of ordinary skill in the art from the foregoing description and accompanying drawings. These other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A folding joint suitable for a baby carriage, including:
an upper rotary plate provided with a positioning hole, a lower rotary plate provided with a positioning hole, a rotary plate outer positioning cover provided with two positioning holes which respectively correspond to the positioning hole in the upper rotary plate and the positioning hole in the lower rotary plate, a rotary plate inner positioning cover provided with two positioning holes which respectively correspond to the positioning hole in the upper rotary plate and the positioning hole in the lower rotary plate, a first traction cable, a second traction cable, and a stopper for preventing said upper rotary plate or said lower rotary plate from turning, wherein:
said upper rotary plate is connected with said rotary plate outer positioning cover and said rotary plate inner positioning cover through the respective positioning holes, thereby forming a pivot point,
said lower rotary plate is connected with said rotary plate outer positioning cover and said rotary plate inner positioning cover through the respective positioning holes, thereby forming another pivot point,
one end of said first traction cable is installed on the upper rotary plate, and another end of said first traction cable is installed on the lower rotary plate, one end of the second traction cable arranged to be staggered with the first traction cable is installed on the upper rotary plate, and another end of the second traction cable is installed on the lower rotary plate,
both of said upper rotary plate and said lower rotary plate are provided with a stopping part at their respective lower ends which is able to be engaged with or released from said stopper,
said upper rotary plate can turn about the pivot point provided in said rotary plate inner positioning cover and said rotary plate outer positioning cover, said lower rotary plate can turn about another pivot point provided in said rotary plate inner positioning cover and said rotary plate outer positioning cover,
said stopper is arranged to be movable with respect to the stopping part of said upper rotary plate and the stopping part of said lower rotary plate, when said stopper is engaged with the stopping part of said upper rotary plate and the stopping part of said lower rotary plate, said upper rotary plate and said lower rotary plate cannot turn about their respective pivot points, when said stopper is released from the stopping part of said upper rotary plate and the stopping part of said lower rotary plate, in the case of turning said upper rotary plate, said lower rotary plate can be turned in an direction opposite to the turning direction of said upper rotary plate by the respective traction cables, and in the case of turning said lower rotary plate, said lower rotary plate can also be turned in an direction opposite to the turning direction of said lower rotary plate by the respective traction cables,
both of said upper rotary plate and said lower rotary plate have a P-shaped rotation arm;
the P-shaped rotation arm of the lower rotary plate is fixedly connected with the front supporting tube of the baby carriage, the P-shaped rotation arm of the upper rotary plate is fixedly connected with the handle tube of the baby carriage, and said rotary plate inner positioning cover and the said rotary plate outer positioning cover are fixedly connected with the rear supporting tube of the baby carriage.

2. The folding joint of claim 1, wherein:
the peripheral end surfaces of said upper rotary plate and said lower rotary plate are provided with corresponding retaining nests for arranging said two traction cables, one end of the first traction cable is installed in a fixed point and the retaining nest in the peripheral end surface of the upper end of said upper rotary plate, and another end of said first traction cable is installed in a fixed point and the retaining nest in the peripheral end surface of the lower end of said lower rotary plate, one end of the second traction cable is installed in a fixed point and the retaining nest in the peripheral end surface of the lower end of said upper rotary plate, and another end of said second traction cable is installed in a fixed point and the retaining nest in the peripheral end surface of the upper end of said lower rotary plate.

3. A folding joint for a baby carriage, comprising:
an upper rotary plate provided with a positioning hole;
a lower rotary plate provided with a positioning hole;
a rotary plate outer positioning cover provided with two positioning holes which respectively correspond to the positioning hole in the upper rotary plate and the positioning hole in the lower rotary plate; and
a rotary plate inner positioning cover provided with two positioning holes which respectively correspond to the positioning hole in the upper rotary plate and the positioning hole in the lower rotary plate, wherein
said upper rotary plate is connected with said rotary plate outer positioning cover and said rotary plate inner positioning cover through the respective positioning holes, thereby forming a first pivot point,
said lower rotary plate is connected with said rotary plate outer positioning cover and said rotary plate inner positioning cover through the respective positioning holes, thereby forming a second pivot point,
wherein said upper rotary plate can turn about the first pivot point and said lower rotary plate can turn about the second pivot point.

4. The folding joint according to claim 3, wherein each of said upper rotary plate and said lower rotary plate have a P-shaped rotation arm, wherein the P-shaped rotation arm of the lower rotary plate is fixedly connected with a front supporting tube of the baby carriage, the P-shaped rotation arm of the upper rotary plate is fixedly connected with a handle tube of the baby carriage, and said rotary plate inner positioning cover and said rotary plate outer positioning cover are fixedly connected with a rear supporting tube of the baby carriage.

5. The folding joint according to claim 3, further comprising a first traction cable, wherein one end of said first traction cable is installed on the upper rotary plate and another end of said first traction cable is installed on the lower rotary plate, the first traction cable being arranged such that rotation of the upper rotary plate in a clockwise direction causes the lower rotary plate to rotate in a counterclockwise direction

6. The folding joint according to claim 5, further comprising a second traction cable, wherein one end of the second traction cable is installed on the upper rotary plate and another end of the second traction cable is installed on the lower rotary plate, the second traction cable being arranged such that rotation of the upper rotary plate in a counterclockwise direction causes the lower rotary plate to rotate in a clockwise direction.

7. The folding joint according to claim 6, wherein respective peripheral end surfaces of said upper rotary plate and said lower rotary plate are provided with corresponding retaining nests for receiving said first and second traction cables, one end of the first traction cable being installed in a fixed point and in small retaining nest in the peripheral end surface of the upper end of said upper rotary plate, and another end of said first traction cable being installed in a fixed point in the small retaining nest in the peripheral end surface of the lower end of said lower rotary plate, one end of the second traction cable being installed in a fixed point in the small retaining nest in the peripheral end surface of the lower end of said upper rotary plate, and another end of said second traction cable being installed in a fixed point in the small retaining nest in the peripheral end surface of the upper end of said lower rotary plate.

8. The folding joint according to claim 3, further comprising and a stopper for preventing said upper rotary plate and said lower rotary plate from turning, each of said upper rotary plate and said lower rotary plate being provided with a stopping part at their respective lower ends, said stopper being arranged to be movable into and out of engagement with the stopping part of said upper rotary plate and the stopping part of said lower rotary plate, wherein when said stopper is engaged with the stopping part of said upper rotary plate and the stopping part of said lower rotary plate said upper rotary plate and said lower rotary plate cannot turn about their respective pivot points, and wherein when said stopper is released from the stopping part of said upper rotary plate and the stopping part of said lower rotary plate said upper rotary plate and said lower rotary plate are allowed to turn about their respective pivot points.
